(19) United States
(12) Patent Application Publication
(10) Pub. No.: US 2005/0096249 A1
(43) Pub. Date: May 5, 2005

(54) Highly concentrated aqueous solution of amphoteric surfactants

(75) Inventors: Ekaterina Jonas, Bad Soden (DE); Rudolf Aigner, Kastl (DE); Guillermo Maier, Haiming (DE); Uwe Meyer, Toeging (DE); Josef Strobl, Wurmansquick (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/946,278

(22) Filed: Sep. 21, 2004

(30) Foreign Application Priority Data
Sep. 22, 2003 (DE) 10343730.4

(51) Int. Cl. C11D 3/37

(52) U.S. Cl. 510/490

(57) ABSTRACT

The invention provides highly concentrated aqueous solutions of a first amphoteric surfactant, especially of betaines or amine oxides, which comprise one or more further amphoteric cosurfactants which have a different structure from the first amphoteric surfactant, in amounts by weight of from 0.01 % to 10%, preferably from 0.1% to 5%, more preferably from 0.5% to 3%, based on the highly concentrated aqueous solution.

The invention relates to highly concentrated aqueous solutions of amphoteric surfactants having an active ingredient content of these surfactants of at least 30% by weight, which are present in the form of pumpable liquids in the presence of small amounts of a further amphoteric surfactant, and to the use thereof.

It is known that amphoteric surfactants, especially betaines, depending on the fatty acids or fatty acid mixtures used for their preparation, form lyotropic crystalline phases above 30% by weight of surfactant in water. These phases are of solid consistency and behave like solids. They are no longer pumpable and are difficult for the user to handle.

As is well known, a reduction in the viscosity of aqueous surfactant solutions can be achieved by adding solvents, for example n-alcohols or polyhydric alcohols. WO 99/24157 describes solutions of betaines which contain precisely defined amounts of betaine, water and ethanol.

EP 560 114 describes aqueous, fluid solutions of a betaine having a solids content of at least 40% by weight, characterized by a content of from 1 to 3% by weight of one or more saturated or unsaturated fatty acids and from 0 to 4% by weight of glycerol, based on the solution. Fatty acid and glycerol are added to the reaction mixture before or during the quaternization of the tertiary amine with chloroacetic acid.

EP-A-353 580 states that the phase behavior of betaines can be influenced by adding nonionic surfactants, although from 3 to 15% by weight of cosurfactant are required.

Addition of nonionic surfactants to amphoteric surfactants alters the surfactant properties, which may be disadvantageous for the user. Solvents and fatty acid fractions are also frequently undesired in the formulation.

It is an object of the invention to prepare very highly concentrated aqueous solutions of amphoteric surfactants, especially betaines or amine oxides, which are pumpable and easy to handle and do not contain any nonionic cosurfactants or organic solvents which are volatile or problematic in environmental toxicology terms. The surfactant solutions should be sufficiently highly concentrated that they are self-preserving owing to the reduced water content and are storage-stable for a long period without bacterial decomposition occurring.

It has been found that, surprisingly, highly concentrated aqueous solutions of an amphoteric surfactant are fluid and have unlimited phase stability in the presence of small amounts of a second amphoteric surfactant having a different structure.

The invention provides highly concentrated aqueous solutions of a first amphoteric surfactant, especially of betaines or amine oxides, which comprise one or more further amphoteric cosurfactants which have a different structure from the first amphoteric surfactant, in amounts by weight of from 0.01% to 10%, preferably from 0.1% to 5%, more preferably from 0.5% to 3%, based on the highly concentrated aqueous solution. The concentration of the first amphoteric surfactant may be set to values of from 30 to 45% by weight, preferably from 30 to 40% by weight, at which the formulation remains fluid.

Both the first amphoteric surfactant and the amphoteric cosurfactant may in particular be those of the following formulae: 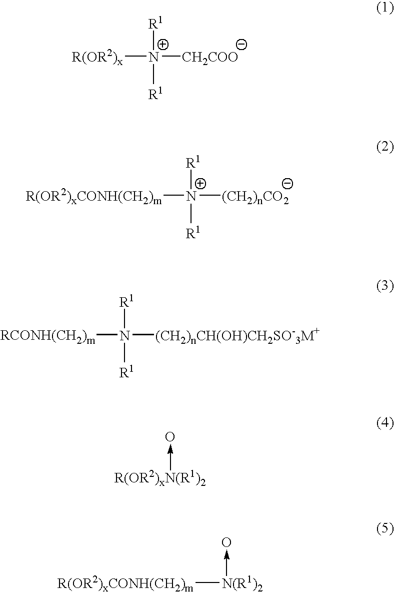
where R is an alkyl, hydroxyalkyl or alkylphenyl group having from 8 to 22 carbon atoms, each R¹ radical is independently an alkyl or hydroxyalkyl group having from 1 to 3 carbon atoms or two R¹ groups are joined together via an —O — or —NH— group with ring formation, R² is an alkylene group having from 2 to 3 carbon atoms or mixtures thereof, and x is a number from 0 to 10. M is H, alkali metal, alkaline earth metal, ammonium or alkanolammonium, and m and n are each numbers from 1 to 4.

Particularly preferred amine oxides are C₁₀-C₁₈-alkyldimethylamine oxides, C₈-C₁₂-alkoxyethyidihydroxyethylamine oxides. Preferred betaines are compounds of the formula (2) where R¹═CH₃, m=3 and n=1.

The process according to the invention for preparing highly concentrated aqueous solutions of amphoteric surfactants is also applicable to N—(C₁₂-C₁₈)-alkyl-β-iminodipropionates, iminopolyalkanoates in the form of alkali metal and mono-, di- and trialkylammonium salts, (C₁₂-C₁₈)-alkyldimethylsulfopropylbetaines, for example cocoylamidopropylhydroxysulfobetaines; amphoteric surfactants based on imidazoline (trade name: Miranol®, Steinapon®), preferably the sodium salt of 1-(β-carboxymethyloxyethyl)-1-(carboxymethyl)-2-laurylimidazolinium, and likewise to alkyl and acylglycinates, for example cocoylglycinates, cocoamphoacetates, cocoamphodiacetates (cocoamphocarboxyglycinate), lauroamphoacetate, cocoamphocarboxypropionates.

For the inventive preparation of highly concentrated aqueous amphoteric surfactant solutions, amphoteric cosurfactants are added in small amounts.

Suitable cosurfactants are all of the abovementioned amphoteric surfactants, with the proviso that amphoteric cosurfactant and amphoteric first surfactant have a different structure. The cosurfactant used may also be an anion-cation complex, for example quaternary ammonium compounds with alkylsulfate, arylsulfate, alkylsulfonate or arylsulfonate. Preferred cosurfactants are compounds of the formula (1) where R¹═CH₃ and x=0. Preference is given overall to mixtures of compounds of the formula (2) where R¹═CH₃, m=3 and n=1, or of amine oxides of the formulae 4 or 5, with compounds of the formula (1) where R¹═CH₃ and x=0.

These highly concentrated aqueous surfactant solutions can be prepared by two methods.

To commercial aqueous surfactant solutions, for example an aqueous solution having 30% by weight cocoamidopropylbetaine (®Genagen CAB), are added one or more further amphoteric cosurfactants at room temperature, the mixture is stirred for from 15 minutes to 30 minutes and the solution is subsequently dehydrated with stirring at from 90 to 100° C., preferably from 95 to 98° C. The concentration of the solution may be accelerated by a nitrogen stream removing water vapor at the surface of the solution.

In this way, surfactant concentrates may be obtained which have a fluid-viscous consistency at room temperature at a surfactant content WS of from 32 to 38% by weight.

In a second method, these highly concentrated surfactant solutions may be obtained by adding one or more further amphoteric cosurfactants to the reaction mixture as early as in the course of the synthesis of the first surfactant. The betaines and amine oxides are synthesized in a known manner. There is no need to modify the synthetic conditions.

The inventive surfactant solutions satisfy the requirement of being free of nonionic surfactants and organic solvents. They are fluid-viscous even at the above-specified content of amphoteric cosurfactant.

The examples which follow are intended to illustrate the invention in detail without restricting it thereto:

### EXAMPLES

### Example 1

### Preparation of a cocoamidopropylbetaine Solution Having an Active Substance Content of 38% in the Presence of 1% lauryldimethylbetaine

212.8 g of demineralized water, 4.32 g of lauryldimethylbetaine solution (30%) (1.0% m/M based on total weight) (®Genagen LAB) and 131.6 g of cocoamidopropylamine (0.40 mol) were initially charged in a 1 l stirred flask and heated to from 75 to 80° C. with stirring. Then, 36.5 ml of monochloroacetic acid (80%) (103.5 n/n based on amidopropylamine) and 21.4 ml of sodium hydroxide solution (50%) (110% n/n based on amidopropylamine) were added within a period of 45 minutes and the mixture was stirred at from 75 to 80° C. for a further 30 minutes. Addition of 1.1 ml of NaOH (50%) adjusted the pH to from 8.0 to 8.5, the temperature was increased to from 80 to 85° C. within 1 hour and the mixture was stirred at from 80 to 85° C. for 1 hour, and subsequently heated to from 85 to 90° C. within 30 minutes and stirred for a further 1 hour and finally heated to from 90 to 95° C. within 30 minutes and stirred at from 90 to 95° C. for a further 5 hours. 4.0 g of citric acid (50%) were used to adjust the pH to from 5.0 to 5.5.

### Example 2

### Preparation of a cocoamidopropylbetaine Solution Having an Active Substance Content of 37% in the Presence of 0.3% lauryidimethylbetaine

220.5 g of demineralized water, 2.2 g of lauryldimethylbetaine solution (30%) (0.3% m/M based on total weight) (®Genagen LAB) and 131.6 g of cocoamidopropylamine (0.40 mol) were initially charged in a 1 l stirred flask and heated to from 75 to 80° C. with stirring. Then, 36.5 ml of monochloroacetic acid (80%) (103.5 n/n based on amidopropylamine) and 21.4 ml of sodium hydroxide solution (50%) (110% n/n based on amidopropylamine) were added within a period of 45 minutes and the mixture was stirred at from 75 to 80° C. for a further 30 minutes. Addition of 1.1 ml of NaOH (50%) adjusted the pH to from 8.0 to 8.5, the temperature was increased to from 80 to 85° C. within 1 hour and the mixture was stirred at from 80 to 85° C. for 1 hour, and subsequently heated to from 85 to 90° C. within 30 minutes and stirred for a further 1 hour and finally heated to from 90 to 95° C. within 30 minutes and stirred at from 90 to 95° C. for a further 5 hours.

4.0 g of citric acid (50%) were used to adjust the pH to from 5.0 to 5.5.

### Example 3

### Preparation of a cocoamidopropylbetaine Solution having an Active Substance Content of 38% in the Presence of 1.0% cocodimethylbetaine

206.5 g of demineralized water, 4.26 g of cocodimethylbetaine solution (30%) (1.0% m/M based on total weight) (®Genamin CSLB) and 131.6 g of cocoamidopropylamine (0.40 mol) were initially charged in a 1 l stirred flask and heated to from 75 to 80° C. with stirring. Then, 36.5 ml of monochloroacetic acid (80%) (103.5 n/n based on amidopropylamine) and 21.4 ml of sodium hydroxide solution (50%) (110% n/n based on amidopropylamine) were added within a period of 45 minutes and the mixture was stirred at from 75 to 80° C. for a further 30 minutes. Addition of 1.1 ml of NaOH (50%) adjusted the pH to from 8.0 to 8.5, the temperature was increased to from 80 to 85° C. within 1 hour and the mixture was stirred at from 80 to 85° C. for 1 hour, and subsequently heated to from 85 to 90° C. within 30 minutes and stirred for a further 1 hour and finally heated to from 90 to 95° C. within 30 minutes and stirred at from 90 to 95° C. for a further 5 hours.

4.0 g of citric acid (50%) were used to adjust the pH to from 5.0 to 5.5.

### EXAMPLE 4

### Preparation of a cocoamidopropylbetaine Solution having an Active Substance Content of 37% in the Presence of 0.5% cocodimethylbetaine

218.0 g of demineralized water, 2.19 g of cocodimethylbetaine solution (30%) (0.5% m/M based on total weight) (OGenamin CSLB) and 131.6 g of cocoamidopropylamine (0.40 mol) were initially charged in a 1 l stirred flask and heated to from 75 to 80° C. with stirring. Then, 36.5 ml of monochloroacetic acid (80%) (103.5 n/n based on amidopropylamine) and 21.4 ml of sodium hydroxide solution (50%) (110% n/n based on amidopropylamine) were added within a period of 45 minutes and the mixture was stirred at from 75 to 80° C. for a further 30 minutes. Addition of 1.1 ml of NaOH (50%) adjusted the pH to from 8.0 to 8.5, the temperature was increased to from 80 to 85° C. within 1 hour and the mixture was stirred at from 80 to 85° C. for 1 hour, and subsequently heated to from 85 to 90° C. within 30 minutes and stirred for a further 1 hour and finally heated to from 90 to 95° C. within 30 minutes and stirred at from 90 to 95° C. for a further 5 hours.

4.0 g of citric acid (50%) were used to adjust the pH to from 5.0 to 5.5.

### EXAMPLE 5

### Concentration of a cocoamidopropylbetaine Solution by Stripping Off Water in the Presence of lauryldimethylbetaine

500 g of cocoamidopropylbetaine solution (®Genagen CAB 818) were admixed with stirring at ambient temperature with 4.0 g of a solution of lauryldimethylbetaine (®Genagen LAB), corresponding to 1.0% by weight based on the end dilution. The active substance content of the two betaine solutions was approx. 30% by weight. The contents of the flask were heated with stirring to a liquid phase temperature of approx. 80° C. At this temperature, the mixture was stirred for a further 30 minutes. Subsequently, the contents of the flask were heated with stirring to approx. 98° C. to strip off water. In order to accelerate the stripping-off of water, a gentle nitrogen stream was conducted over the surface of the betaine solution. When the calculated amount of water had been stripped off, the contents of the flask were cooled to approx. 60° C. with stirring and transferred. The content of water and sodium chloride in this concentrated cocoamidopropylbetaine solution was determined. In this way, 407 g of cocoamidopropylbetaine in fluid-viscous form at room temperature and having an active substance content of 37% were obtained.

### EXAMPLE 6

### Concentration of a cocodimethylamine oxide Solution by Stripping Off Water in the Presence of lauryldimethylbetaine (®Genagen LAB)

500 g of a solution of cocodimethylamine oxide (®Genaminox CST) were admixed with stirring at ambient temperature with 2.04 g of lauryldimethylbetaine solution (®Genagen LAB), corresponding to 0.5% by weight based on the end dilution. The active substance content of the two betaine solutions was approx. 30% by weight. The contents of the flask were heated with stirring to a liquid phase temperature of approx. 80° C. At this temperature, the mixture was stirred for a further 30 minutes. Subsequently, the contents of the flask were heated with stirring to approx. 98° C. to strip off water. In order to accelerate the stripping-off of water, a gentle nitrogen stream was conducted over the surface of the amine oxide solution. When the calculated amount of water had been stripped off, the contents of the flask were cooled to approx. 60° C. with stirring and transferred. The content of amine oxide in this concentrated cocodimethylamine oxide solution was determined. In this way, 410 g of cocodimethylamine oxide in fluid-viscous form at room temperature and having an active substance content of 36% were obtained.

According to the invention, the above-described surfactant concentrates may generally be used in all detergents, disinfectants and bleaches of any type, especially in the form of aqueous, aqueous/organic, especially aqueous/alcoholic and organic formulations.

In a further preferred embodiment, the inventive concentrates are used in rinse-off products, preferably shampoos, shower preparations, shower gels and foam baths.

The inventive compositions may comprise anionic, cationic, nonionic, zwitterionic and/or further amphoteric surfactants, and also assistants and additives such as oily substances, emulsifiers and coemulsifiers.

Cosmetic products may comprise conventional additives, for example cationic polymers, film formers, superfatting agents, stabilizers, biogenic active ingredients, glycerol, preservatives, pearlizing agents, colorants and fragrances, solvents, solubilizers, thickeners, opacifiers, and also protein derivatives such as gelatin, collagen hydrolyzates, polypeptides on natural and synthetic basis, egg yolk, lecithin, lanolin and lanolin derivatives, fatty alcohols, silicones, deodorants, substances having keratolytic and keratoplastic action, enzymes and carrier substances. In addition, antimicrobial agents may be added to the inventive compositions.

The inventive detergents and disinfectants may comprise further specific assistants and additives, for example salts, bleaches, bleach activators, optical brighteners, graying inhibitors, preservatives, fragrances and colorants, foam inhibitors and sequestering agents.

Preferred anionic surfactants are (C₁₀-C₂₀)-alkyl- and alkylenecarboxylates, alkyl ether carboxylates, fatty alcohol sulfates, fatty alcohol ether sulfates, alkylamide sulfates and sulfonates, fatty acid alkylamide polyglycol ether sulfates, alkanesulfonates and hydroxyalkanesulfonates, olefinsulfonates, acyl esters of isethionates, α-sulfo fatty acid esters, alkylbenzenesulfonates, alkylphenol glycol ether sulfonates, sulfosuccinates, sulfosuccinic monoesters and diesters, fatty alcohol ether phosphates, protein-fatty acid condensates, alkylmonoglyceride sulfates and sulfonates, alkylglyceride ether sulfonates, fatty acid methyltaurides, fatty acid sarcosinates, sulforicinoleates, acylglutamates. These compounds and mixtures thereof are utilized in the form of their water-soluble or water-dispersible salts, for example the sodium, potassium, magnesium, ammonium, mono-, di- and triethanolammonium and also analogous alkylammonium salts.

Preferred cationic surfactants are quaternary ammonium salts such as di(C₁₀-C₂₄)-alkyldimethylammonium chloride or bromide, preferably di-(C₁₂-C₁₈)-alkyldimethylammonium chloride or bromide; (C₁₀-C₂₄)-alkyldimethyl-ethylammonium chloride or bromide; (C₁₀-C₂₄)-alkyltrimethylammonium chloride or bromide, preferably cetyl-trimethylammonium chloride or bromide and (C₂₀-C₂₂)-alkyl-trimethylammonium chloride or bromide; (C₁₀-C₂₄)-alkyldimethylbenzyl-ammonium chloride or bromide, preferably (C₁₂-C₁₈)-alkyldimethylbenzylammonium chloride; N—(C₁₀-C₁₈)-alkylpyridinium chloride or bromide, preferably N—(C₁₂-C₁₆)-alkylpyridinium chloride or bromide; N—(C₁₀-C₁₈)-alkylisoquinolinium chloride, bromide or monoalkyl sulfate; N—(C₁₂-C₁₈)-alkylpolyoylaminoformylmethylpyridinium chloride; N—(C₁₂-C₁₈)-alkyl-N-methylmorpholinium chloride, bromide or monoalkylsulfate; N—(C₁₂-C₁₈)-alkyl-N-ethylmorpholinium chloride, bromide or monoalkyl sulfate; (C₁₆-C₁₈)-alkylpentaoxethylammonium chloride; diisobutylphenoxyethoxyethyidimethylbenzylammonium chloride; salts of N,N-diethylaminoethylstearylamide and oleylamide with hydrochloric acid, acetic acid, lactic acid, citric acid, phosphoric acid; N-acylaminoethyl-N,N-diethyl-N-methylammonium chloride, bromide or monoalkyl sulfate and N-acylaminoethyl-N,N-diethyl-N-benzylammonium chloride, bromide or monoalkyl sulfate, acyl preferably being stearyl or oleyl.

Preferred nonionic surfactants are fatty alcohol ethoxylates(alkylpolyethylene glycols); alkylphenol polyethylene glycols; alkyl mercaptan polyethylene glycols; fatty amine ethoxylates(alkylamino polyethylene glycols); fatty acid ethoxylates(acylpolyethylene glycols); polypropylene glycol ethoxylates (Pluronics®); fatty acid alkylolamides, (fatty acid amide polyethylene glycols); N-alkyl-, N-alkoxypolyhydroxy fatty acid amide, sucrose esters; sorbitol esters and the polyglycol ethers.

Preferred amphoteric surfactants are N—(C₁₂-C₁₈)-alkyl-β-aminopropionates and N—(C₁₂-C₁₈)-alkyl-p-iminodipropionates as the alkali metal and mono-, di- and trialkylammonium salts; N-acylaminoalkyl-N,N-dimethylacetobetaine, preferably N—(C₈-C₁₈)-acylaminopropyl-N,N-dimethylacetobetaine; (C₁₂-C₁₈)-alkyldimethyl-sulfopropylbetaine; amphoteric surfactants based on imidazoline (trade name: Miranol®, Steinapon®), preferably the sodium salt of 1-(β-carboxymethyloxyethyl)-1-(carboxymethyl)-2-laurylimidazolinium; amine oxide, for example (C₁₂-C₁₈)-alkyldimethylamine oxide, fatty acid amidoalkyldimethylamine oxide.

Preferred surfactants are lauryl sulfate, laureth sulfate, cocoamidopropylbetaine, sodium cocoylglutamate, lauroamphoacetate.

The compositions may additionally comprise foam-reinforcing cosurfactants from the group of the aminopropionates, aminoglycinates, alkanolamides and polyhydroxyamides.

Useful nonionogenic coemulsifiers include addition products of from 0 to 30 mol of ethylene oxide and/or from 0 to 5 mol of propylene oxide to linear fatty alcohols having from 8 to 22 carbon atoms, to fatty acids having from 12 to 22 carbon atoms, to alkylphenols having from 8 to 15 carbon atoms in the alkyl group and to sorbitan or sorbitol esters; (C₁₂-C₁₈) fatty acid mono- and diesters of addition products of from 0 to 30 mol of ethylene oxide to glycerol; glycerol mono- and diesters and sorbitan mono- and diesters of saturated and unsaturated fatty acids having from 6 to 22 carbon atoms and, if desired, their ethylene oxide addition products; addition products of from 15 to 60 mol of ethylene oxide to castor oil and/or hydrogenated castor oil; polyol and in particular polyglycerol esters, for example polyglycerol polyricinoleate and polyglycerol poly-12-hydroxystearate. Likewise suitable are mixtures of compounds from a plurality of these substance classes.

Suitable ionogenic coemulsifiers are, for example, anionic emulsifiers such as mono-, di- or triphosphate esters, but also cationic emulsifiers such as mono-, di- and trialkyl quats and polymeric derivatives thereof.

Suitable cationic polymers include those known under the INCl designation “olyquaternium”, especially Polyquaternium-31, Polyquaternium-16, Polyquaternium-24, Polyquaternium-7, Polyquaternium-22, Polyquaternium-39, Polyquaternium-28, Polyquaternium-2, Polyquaternium-10, Polyquaternium-11, and also Polyquaternium 37&mineral oil&PPG trideceth (Salcare SC95), PVP-dimethylaminoethyl methacrylate copolymer, guar-hydroxypropyltriammonium chlorides, and also calcium alginate and ammonium alginate. It is additionally possible to use cationic cellulose derivatives; cationic starch; copolymers of diallylammonium salts and acrylamides; quaternized vinylpyrrolidone/vinylimidazole polymers; condensation products of polyglycols and amines; quaternized collagen polypeptides; quaternized wheat polypeptides; polyethylenimines; cationic silicone polymers, for example amidomethicones; copolymers of adipic acid and dimethylaminohydroxypropyldiethylenetriamine; polyaminopolyamide and cationic chitin derivatives, for example chitosan. Examples of suitable silicone compounds are dimethylpolysiloxane, methylphenylpolysiloxanes, cyclic silicones, and amino-, fatty acid-, alcohol-, polyether-, epoxy-, fluoro- and/or alkyl-modified silicone compounds, and also polyalkylsiloxanes, polyalkylarylsiloxanes, polyethersiloxane copolymers, as described in U.S. Pat. No. 5,104,645 and the documents cited therein, which at room temperature may be present either in liquid form or in resin form.

Suitable film formers, depending on the application, are water-soluble polyurethanes, for example C10-polycarbamyl polyglyceryl esters, polyvinyl alcohol, polyvinylpyrrolidone, copolymers thereof, for example vinylpyrrolidone/vinyl acetate copolymer, water-soluble acrylic acid polymers/copolymers and their esters or salts, for example partial ester copolymers of acrylic/methacrylic acid and polyethylene glycol ethers of fatty alcohols, such as acrylate/steareth-20 methacrylate copolymer, water-soluble cellulose, for example hydroxymethylcellulose, hydroxyethylcellulose, hydroxypropylcellulose, water-soluble quaterniums, polyquaterniums, carboxyvinyl polymers, such as carbomers and their salts, polysaccharides, for example polydextrose, and glucan.

Examples of the superfatting agents used may be substances such as polyethoxylated lanolin derivatives, lecithin derivatives, polyol fatty acid esters, monoglycerides, and fatty acid alkanolamides, the latter serving simultaneously as foam stabilizers. Available moisturizers include, for example, isopropyl palmitate, glycerol and/or sorbitol.

Examples of the stabilizers used may be metal salts of fatty acids, such as magnesium, aluminum and/or zinc stearate.

The inventive compositions can be blended with conventional ceramides, pseudoceramides, fatty acid N-alkylpolyhydroxyalkyl amides, cholesterol, cholesterol fatty acid esters, fatty acids, triglycerides, cerebrosides, phospholipids, and similar substances as a care additive.

Examples of useful preservatives include phenoxyethanol, parabens, pentanediol or sorbic acid.

The dyes used may be the substances which are suitable and approved for cosmetic purposes.

Useful antifungal active ingredients (fungicides) include preferably ketoconazole, oxiconazole, bifonazole, butoconazole, cloconazole, clotrimazole, econazole, enilconazole, fenticonazole, isoconazole, miconazole, sulconazole, tioconazole, fluconazole, itraconazole, terconazole, naftifine and terbinafine, Zn pyrethion, and octopyrox.

In order to adjust the rheological properties of aqueous or solventborne emulsions or suspensions, the technical literature specifies a multitude of different systems. Examples of known systems are cellulose ethers and other cellulose derivatives (e.g. carboxymethylcellulose, hydroxyethylcellulose), gelatin, starch and starch derivatives, sodium alginates, fatty acid polyethyleneglycol esters, agar-agar, tragacanth or dextrins. The synthetic polymers used are various materials, for example polyvinyl alcohols, polyacrylamides, polyvinylamides, polysulfonic acids, polyacrylic acid, polyacrylic esters, polyvinylpyrrolidone, polyvinyl methyl ether, polyethylene oxides, copolymers of maleic anhydride and vinyl methyl ether, and also various mixtures and copolymers of the abovementioned compounds, including their different salts and esters. These polymers may, as desired, be crosslinked or uncrosslinked.

The inventive compositions may comprise, as foam inhibitors, fatty acid alkyl ester alkoxylates, organopolysiloxanes and mixtures thereof with microfine, optionally silanized silica and also paraffins, waxes, microcrystalline waxes and mixtures thereof with silanized silica.

Advantageously, mixtures of different foam inhibitors may also be used, for example those composed of silicone oil, paraffin oil or waxes. Foam inhibitors are preferably bonded to a granular carrier substance soluble or dispersible in water.

The desired viscosity of the compositions may be adjusted by adding water and/or organic solvents or by adding a combination of organic solvents and thickeners.

In principle, useful organic solvents are all mono- or polyhydric alcohols.

Preference is given to alcohols having from 1 to 4 carbon atoms such as methanol, ethanol, propanol, isopropanol, straight-chain and branched butanol, glycerol and mixtures of the alcohols mentioned.

Further preferred alcohols are polyethylene glycols having a relative molecular mass below 2000. Special preference is given to using polyethylene glycol having a relative molecular mass between 200 and 600 and in amounts of up to 45% by weight,. and polyethylene glycol having a relative molecular mass between 400 and 600 in amounts of from 5 to 25% by weight. An advantageous mixture of solvents consists of monomeric alcohol, for example ethanol and polyethylene glycol in a ratio of from 0.5:1 to 1.2:1, and the inventive neutral detergents may contain from 8 to 12% by weight of such a mixture. Further suitable solvents are, for example, triacetin (glycerol triacetate) and 1-methoxy-2-propanol.

The thickeners used are preferably hydrogenated castor oil, salts of long-chain fatty acids, preferably in amounts of from 0 to 5% by weight and especially in amounts of from 0.5 to 2% by weight, for example sodium, potassium, aluminum, magnesium and titanium stearates or the sodium and/or potassium salts of behenic acid, and also polysaccharides, especially xanthan gum, guar-guar, agar-agar, alginates and tyloses, carboxymethylcellulose and hydroxyethylcellulose, and also relatively high molecular weight polyethylene glycol mono- and diesters of fatty acids, polyacrylates, polyvinyl alcohol and polyvinylpyrrolidone.

In order to bind traces of heavy metals, the salts of polyphosphoric acids, such as 1-hydroxyethane-1,1-diphosphonic acid (HEDP) and diethylenetriaminepentamethylenephosphonic acid (DTPMP) may be used.

Examples of useful pearlizing agents are glycol distearic esters such as ethylene glycol distearate, but also fatty acid monoglycol esters.

The salts or extenders used may be, for example, sodium chloride, sodium sulfate, sodium carbonate or sodium silicate (waterglass).

Typical individual examples of further additives include sodium borate, starch, sucrose, polydextrose, stilbene compounds, methylcellulose, toluenesulfonate, cumenesulfonate, soaps and silicones.

The formulation examples which follow are intended to illustrate the invention in detail without restricting it thereto.

All percentages are percentages by weight. The percentages by weight are each based on 100% washing substance.

### Example 1

### Neutral Detergent

Composition:

| | | |
|---|---|---|
| A | ® Genapol LRO liquid | 12% |
| | ® Hostapur SAS 60 | 6% |
| | ® Genapol OA 070 | 5% |
| | ® Genapol TSM | 3% |
| B | ® Genagen CAB 818 | 3% |
| | Deionized water | ad 100% |
| | Dye, preservative, perfume | q.s. |
| C | Sodium chloride | 0.7% |

Preparation:
I The components of A were mixed
II Components B were added
III Subsequently C was used to adjust the viscosity and the mixture was homogenized efficiently

### Example 2

### Manual Dishwashing Composition

Composition:

| | | |
|---|---|---|
| A | ® Hostapur SAS 60 | 38.9% |
| B | Deionized water | ad 100% |
| C | ® Genapol LRO paste | 16.7% |
| | ® Genagen CAB 818 | 16.7% |
| D | EtOH | 2.8% |
| | Perfume, dye, preservative | q.s. |

Preparation Method:
I Dissolution of A in B
II Successive addition of the compnents C with vigorous stirring
III Addition of D and homogenization

### Example 3

### Universal Detergent Paste

| | | |
|---|---|---|
| A | ® Genapol LRO liquid | 42.8% |
| | ® Hostapur SAS 60 | 13.3% |
| B | Deionized water | ad 100% |
| C | ® Hostapon CLG | 8.3% |
| | ® Genagen CAB 818 | 8.3% |
| | ® Genapol PGM | 3.0 |
| | Preservative, perfume | q.s |
| D | NaCl | |

Preparation Method:
I Mixing of component A
II Addition and dissolution of B
III Successive addition of components C with vigorous stirring
IV Adjusting the viscosity with D

### Example 4

### Light-Duty Detergent

| | | |
|---|---|---|
| A | ® Hostapur SAS 60 | 9.0% |
| B | Demineralized water | ad 100% |
| C | ® Genapol LRO liquid | 35.0% |
| | ® Genagen CAB 818 | 10.0% |
| | ® Genapol OA 050 | 1.0% |
| D | NaCl | 0.8% |

Preparation Method:
I Dissolution of A in B
II Successive addition of components C with vigorous stirring
III Adjustment of the viscosity with D

### Example 5

### Shower Preparation

| | Component | % by wt. |
|---|---|---|
| 1 | PEG-120 methyl glucose dioleate | 2.25 |
| 2 | Polyquaternium-10 | 0.3 |
| 3 | Glycerol | 2.0 |
| 4 | Polyester | 5.0 |
| 5 | Coconut fatty acid | 2.0 |
| 6 | Medialan LD | 2.0 |
| 7 | Genapol LRO | 3.15 |
| 8 | Genagen LDA | 5.4 |
| 9 | Genagen CAB | 3.0 |
| 10 | Hostapon CLG | 3.6 |
| 11 | Citric acid 25% | 1.05 |
| 12 | Methyldibromoglutaronitrile/phenoxyethanol | 0.05 |
| 13 | Perfume | 0.5 |
| 14 | Styrene-sodium acrylate copolymer/ | 0.8 |
| | sodium laurylsulfate/trideceth-7 | |
| 15 | Demineralized water | ad 100 |

Components 1, 2, 4 and 5 were initially charged and dissolved with stirring in demineralized water at approx. 70° C. 6, 7, 8, 9, 10 and 3 were added successively with stirring and the pH adjusted to pH 6.2 using citric acid. Addition of 12 and 13 preserved and perfumed the composition and it was provided with the opacifier 14.

### Example 6

### Shower Gel

| | Component | % by wt. |
|---|---|---|
| 1 | ® Carbopol ETD 2020 | 1.5 |
| 2 | ® Polyquaternium-10 | 0.3 |
| 3 | Glycerol | 2.0 |
| 4 | ® Emulsogen SRO | 2.0 |
| 5 | ® Genagen LDA | 9.2 |
| 6 | ® Genagen CAB | 4.0 |
| 7 | ® Hostapon CLG | 4.8 |
| 8 | Citric acid | 0.5 |
| 9 | Methyldibromoglutaronitrile/phenoxyethanol | 0.05 |
| 10 | Perfume | 0.5 |
| 11 | ® Opacifier 641 | 0.8 |
| 12 | Demineralized water | ad 100 |

Components 1 and 2 were initially charged and dissolved with stirring in demineralized water at approx. 70° C. 3, 4, 5, 6 and 7 were added successively with stirring and the pH adjusted to pH 6.0 using citric acid. Addition of 9 and 10 preserved and perfumed the composition and it was subsequently provided with the opacifier 11.

### Example 7

### Shower Gel

| | Component | % by wt. |
|---|---|---|
| 1 | ® Carbopol ETD 2020 | 3.0 |
| 2 | ® Polyquaternium-10 | 0.3 |
| 3 | ® Emulsogen SRO | 3.0 |
| 4 | ® Medialan LD | 2.0 |
| 5 | ® Genagen LAA | 7.2 |
| 6 | ® Genagen CAB | 4.0 |
| 7 | ® Hostapon KCG | 6.9 |
| 8 | Lactic acid | 0.5 |
| 9 | Preservative | q.s. |
| 10 | Perfume | q.s. |
| 11 | ® Genapol TSM | 1.0 |
| 12 | Demineralized water | ad 100 |

Components 1 and 2 were initially charged and dissolved with stirring in demineralized water at approx. 70° C. 3, 4, 5, 6 and 7 were added successively with stirring and the pH adjusted to pH 6.0 using lactic acid. Addition of 9 and 10 preserved and perfumed the composition and it was subsequently provided with the pearlizing agent 11.

Index of the products used

| | | |
|---|---|---|
| ® Carbopol ETD 2020 | (Clariant GmbH) | Polyacrylic acid, crosslinked |
| SRO ® Emulsogen | (Clariant GmbH) | Sorbitol ester based |
| | | on rapeseed oil |
| ® Genagen LDA | (Clariant GmbH) | Lauryl amphodiacetate, |
| | | Na salt |
| ® Genagen LAA | (Clariant GmbH) | Lauryl amphoacetate, Na salt |
| ® Genagen CAB 818 | (Clariant GmbH) | Cocoamidopropylbetaine |
| ® Hostapon CLG | (Clariant GmbH) | Sodium laurylglutamate |
| ® Hostapon KCG | (Clariant GmbH) | Sodium cocoylglutamate |
| ® Medialan LD | (Clariant GmbH) | Sodium lauroylsarcosinate |
| ® Genapol TSM | (Clariant GmbH) | PEG-3 distearate, sodium |
| | | laureth sulfate |
| ® Opacifier 641 | | Na methacrylate-styrene |
| | | copolymer |

| | |
|---|---|
| Hostapur ® SAS 60: | secondary sodium alkanesulfonate |
| | (approx. 60% WAS) |
| Genapol ® LRO: | sodium C₁₂-C₁₄-alkyldiglycol |
| | ether sulfate (30% WAS) |
| Genapol ® OA 050 | C₁₂-C₁₄ oxyalcohol polyglycol ether with 5 EO |
| Genapol ® OA 070 | C₁₂-C₁₄ oxyalcohol polyglycol ether with 7 EO |

Polyester approx. 40 mol % terephthalic acid, approx. 10 mol % ethylene glycol, approx. 10 mol % propylene glycol, approx. 20 mol % polyethylene glycol, approx. 10 mol % fatty alcohol ethoxylate, approx. 10 mol % polyol.

1. A highly concentrated aqueous solution of a first amphoteric surfactant comprising one or more amphoteric cosurfactants which have a different structure from the first amphoteric surfactant, in amounts by weight of from 0.01% to 10%, based on the highly concentrated aqueous solution.

2. The highly concentrated aqueous solution as claimed in claim 1, wherein the first amphoteric surfactant is selected from the group consisting of compounds the formulae (1) to (5), and mixtures thereof 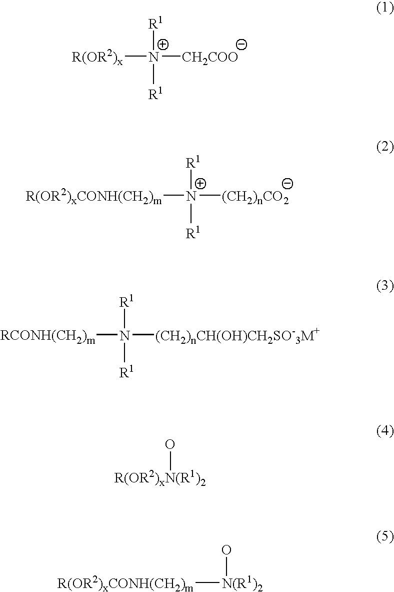
where
R is an alkyl, hydroxyalkyl or alkylphenyl group having from 8 to 22 carbon atoms, each R¹ radical is independently an alkyl or hydroxyalkyl group having from 1 to 3 carbon atoms or two R¹ groups are joined together via an —O— or —NH— group with ring formation, R² is an alkylene group having from 2 to 3 carbon atoms or mixtures thereof, and x is a number from 0 to 10, M is H, alkali metal, alkaline earth metal, ammonium or alkanolammonium, and m and n are each numbers from 1 to 4.

3. The highly concentrated aqueous solution as claimed in claim 1, as wherein the first amphoteric surfactant comprises a compound of the formula 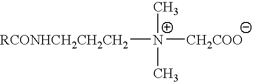
where R is C₈-C22-alkyl.

4. The highly concentrated aqueous solution as claimed in claim 1, as a wherein the one or more amphoteric cosurfactant comprises a compound of the formula 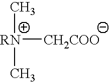
wherei R is C₈-C₂₂-alkyl.

5. The highly concentrated aqueous solution as claimed in claim 1, wherein said solution comprises from 0.01 to 10% by weight of amphoteric cosurfactant based on said solution.

6. The highly concentrated aqueous solution as claimed in claim 1, wherein said solution comprises from 0.1 to 5% by weight of amphoteric cosurfactant based on said solution.

7. The highly concentrated aqueous solution as claimed in claim 1, which comprises from 0.5 to 3% by weight of amphoteric cosurfactant based on said solution.

8. The highly concentrated aqueous solution as claimed in claim 1, wherein said solution comprises from 30 to 45% by weight of the first amphoteric surfactant.

9. The highly concentrated aqueous solution as claimed in claim 1, wherein said solution comprises from 30 to 40% by weight of the first amphoteric surfactant.

10. A cosmetic composition comprising the highly concentrated aqueous solution as claimed in claim 1.

11. A detergent and disinfectant comprising the highly concentrated aqueous solution as claimed in claim 1.
